(19) United States
(12) Patent Application Publication
(10) Pub. No.: US 2022/0261198 A1
(43) Pub. Date: Aug. 18, 2022

(54) PRINTING SYSTEM AND SERVER

(71) Applicant: SEIKO EPSON CORPORATION, Tokyo (JP)

(72) Inventors: Shinichi TSURUYAMA, Shiojiri-shi (JP); Takashi SERA, Shiojiri-shi (JP); Masaki FUKIAGE, Shiojiri-shi (JP)

(21) Appl. No.: 17/650,912

(22) Filed: Feb. 14, 2022

(30) Foreign Application Priority Data
Feb. 16, 2021 (JP) 2021-022336

(51) Int. Cl. G06F 3/12; G06F 3/16

(52) U.S. Cl. CPC G06F 3/1275; G06F 3/167; G06F 3/1273; G06F 3/1288; G06F 3/1205

(57) ABSTRACT

A printing system includes a printing device; and a server connected to the printing device via a network. The server includes: an instruction acquisition unit that acquires an instruction verbally given by a user from a voice mediation device, the instruction including a print instruction; a transmitter that transmits print data based on the acquired print instruction to the printing device; a storage that stores a history of printing based on the print instruction in association with identification information of the user; and a management unit that generates management information to manage the printing by the user based on the history in association with the identification information. The transmitter transmits the generated management information to a notification destination. The printing device receives the print data, and performs printing in accordance with the print data.

The present application is based on, and claims priority from JP Application Serial Number 2021-022336, filed Feb. 16, 2021, the disclosure of which is hereby incorporated by reference herein in its entirety.

### BACKGROUND

### 1. Technical Field

The present disclosure relates to a printing system and a server, the printing system including a printing device and the server.

### 2. Related Art

In recent years, printing has been performed by a printer via a server computer which provides a cloud printing service. Also, in recent years, smart speakers in coordination with a voice recognition service on the cloud have been sold on the market.

JP-A-2019-20873 discloses a printing system including a voice control device, an information terminal, a display unit, a printer, an access point, and a server. When a user gives an instruction for printing content via voice, the voice control device transmits voice data to the server, the server generates print data based on the voice data, and causes the printer to perform printing.

When the number of pages to be printed is large or the operating time of the printer is long, the cost for the printing increases. However, the user cannot obtain the number of pages to be printed and the operating time of the printer by a verbal instruction.

### SUMMARY

A printing system according to an aspect of the present disclosure includes: a printing device; and a server connected to the printing device via a network, wherein the server includes: an instruction acquisition unit that acquires an instruction verbally given by a user from a voice mediation device, the instruction including a print instruction; a transmitter that transmits print data based on the acquired print instruction to the printing device; a storage that stores a history of printing based on the print instruction in association with identification information of the user; and a management unit that generates management information to manage the printing by the user based on the history in association with the identification information, the transmitter transmits the generated management information to a notification destination, and the printing device receives the print data, and performs printing in accordance with the print data.

A server according to an aspect of the present disclosure is connected via a network to a printing device which performs printing in accordance with received data, the server including: an instruction acquisition unit that acquires an instruction verbally given by a user from a voice mediation device, the instruction including a print instruction; a transmitter that transmits print data based on the acquired print instruction to the printing device; a storage that stores a history of printing based on the print instruction in association with identification information of the user; and a management unit that generates management information to manage the printing by the user, based on the history associated with the identification information. The transmitter transmits the generated management information to the notification destination.

### BRIEF DESCRIPTION OF THE DRAWINGS

FIG. 1 is a block diagram schematically illustrating a configuration example of a system including a printing system.

FIG. 2 is a block diagram schematically illustrating a configuration example of a server.

FIG. 3 is a table schematically illustrating a structural example of print history stored in a storage.

FIG. 4 is a block diagram schematically illustrating a configuration example of a printing device.

FIG. 5 is a block diagram schematically illustrating a configuration example of a voice I/O device.

FIG. 6 is a table schematically illustrating an example of management information.

FIG. 7 is a chart schematically illustrating an example of a process of printing content by voice input.

FIG. 8 is a chart schematically illustrating an example of a process of setting a notification destination and notifying the notification destination of management information.

FIG. 9 is a flowchart schematically illustrating an example of a management information notification process.

FIG. 10 is a table schematically illustrating an example of output of management information.

FIG. 11 is a table schematically illustrating an example of output of management information in which verbal instruction print and non-verbal instruction print are separated.

FIG. 12 is a chart schematically illustrating an example of a process of receiving an instruction for date and notifying of management information.

FIG. 13 is a chart schematically illustrating an example of a process of receiving an instruction for print conditions and notifying of management information.

### DESCRIPTION OF EXEMPLARY EMBODIMENTS

Hereinafter, embodiments of the present disclosure will be described. The following embodiments are merely examples of the present disclosure, and all the features shown in the embodiments are not necessarily required for the solution in the present disclosure.

### 1. Summary of Techniques

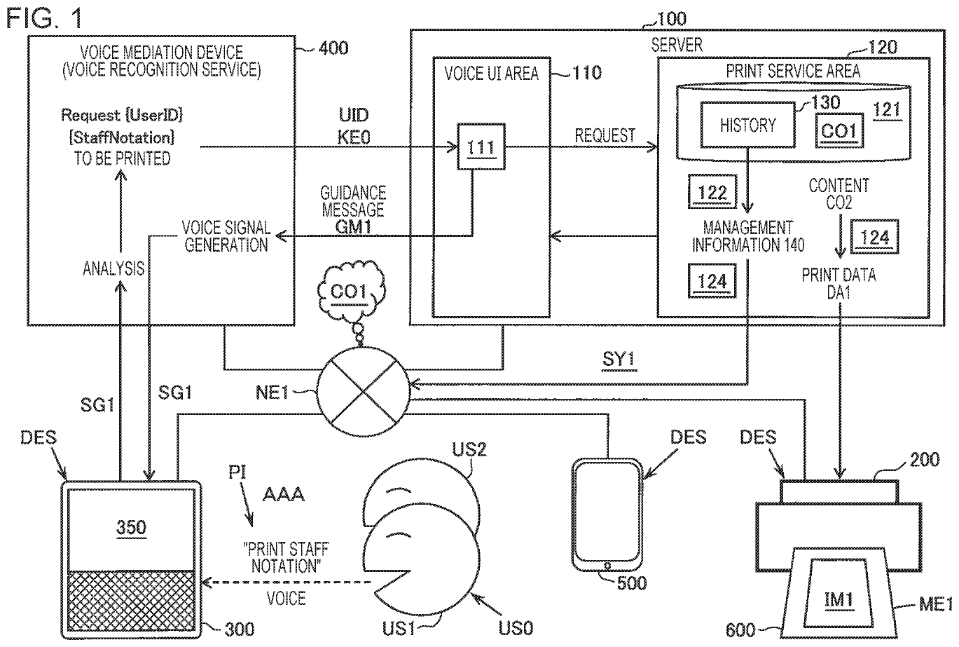

First, a summary of techniques will be described with reference to the examples illustrated in FIGS. 1 to 13. Note that the drawings of the present application schematically illustrate examples, and the enlargement factors in the directions shown in these drawings may be different, thus the drawings may be inconsistent. Each component of the present technique is not limited to the specific example shown by a symbol. In the “summary of techniques”, each term with subsequent parentheses has a supplementary explanation therein.

### Aspect 1

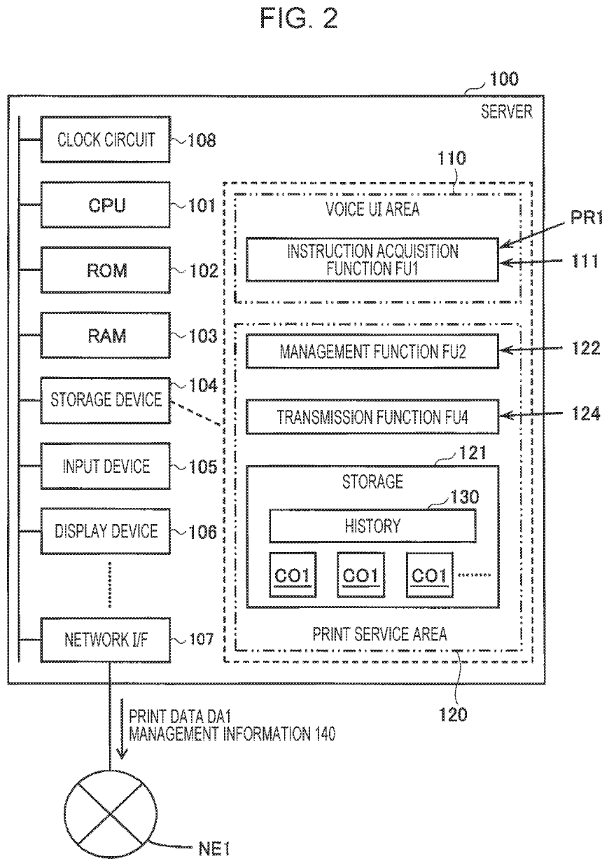

As illustrated in FIGS. 1 and 2, a printing system SY1 according to an aspect of the present technique includes a printing device (for example, a printer 200), and a server 100 connected to the printing device (200) via a network NE1. The server 100 includes an instruction acquisition unit 111, a transmitter 124, a storage 121, and a management unit 122. The instruction acquisition unit 111 acquires an instruction verbally given by the user US0 from a voice mediation device 400, the instruction including a print instruction PI. The transmitter 124 transmits print data DA1 based on the acquired print instruction PI to the printing device (200). The storage 121 stores a history 130 of printing based on the print instruction PI in association with identification information (for example, UID) of the user US0. The management unit 122 generates management information 140 based on the history 130 in association with the identification information (UID), the management information 140 for managing the printing by the user US0. The transmitter 124 transmits the generated management information 140 to a notification destination DES. The printing device (200) receives the print data DA1, and performs the printing in accordance with the print data DA1.

In the aspect 1 described above, when the user US0 utters print instruction PI, history 130 of printing based on the print instruction PI is stored in the storage 121 in association with the identification information (UID) of the user US0. Management information 140 to manage the printing by the user US0 is generated based on the history 130 stored in the storage 121. Since the management information 140 is transmitted to the notification destination DES, the aspect 1 allows the number of printed pages to be obtained by a verbal instruction, thus the printing system SY1 can be provided which improves the convenience in printing management.

Here, the server 100 refers to a computer that provides data, and may be a single computer or multiple computers connected to each other. The management information 140 includes the number of pages of printed material 600 produced by the user US0 in a predetermined period, the number of page limitation information INP which indicates whether the number of pages has reached an upper limit number, the time during which the printing device (200) is operated by the user US0 in a predetermined period, operating time limitation information ITO which indicates whether the time has reached an upper limit time, the number of types of content printed by the user US0 in a predetermined period, and the number of type limitation information INC which indicates whether the number of types has reached an upper limit number. The notification destination includes a voice I/O device (for example, a smart speaker 300), the printing device (200) which are connected to the voice mediation device 400 via the network NE1, and a terminal 500 connected to the server 100 via the network NE1. The above-described additional remark is applied to the following aspects.

### Aspect 2

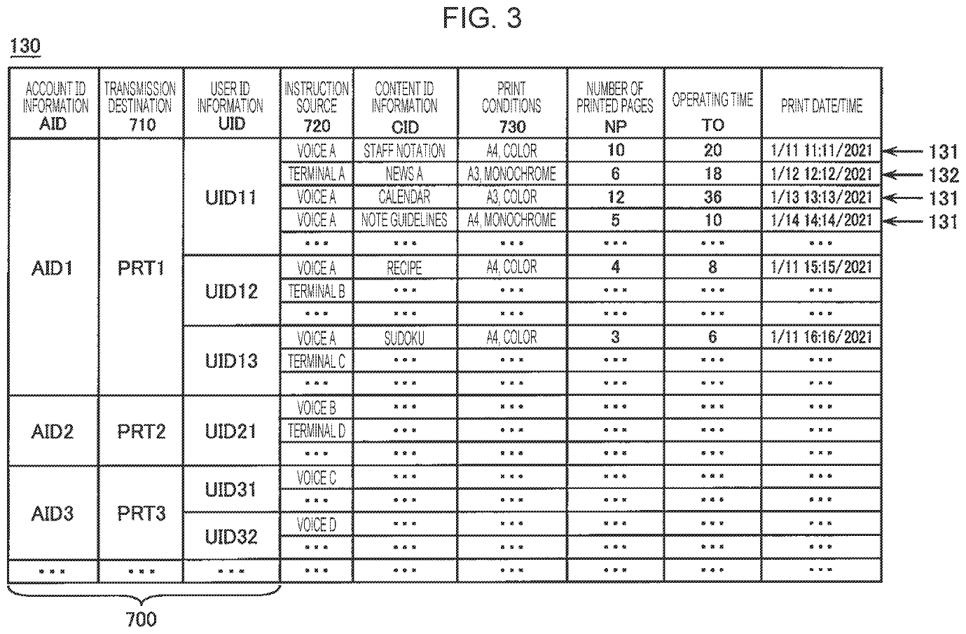

As illustrated in FIG. 3, the identification information (UID) of the user US0 may be associated with account information 700 which includes a transmission destination 710 of the printing device (200). The transmitter 124 may transmit the print data DA1 to the printing device (200) indicated by the account information 700 associated with the identification information (UID). The present aspect can provide a printing system SY1 suitable when multiple users US0 share the printing device (200).

### Aspect 3

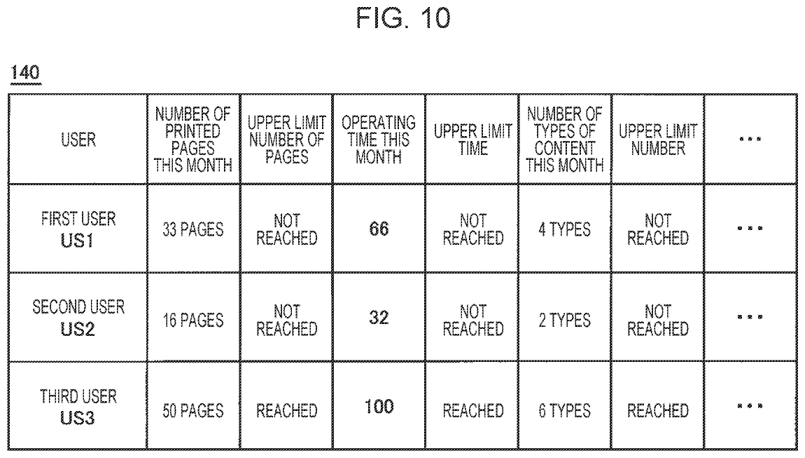

As illustrated in FIG. 10, the identification information (UID) may be associated with the account information 700. The history 130 may be associated with the identification information (UID). The management information 140 may be related to the user US0 indicated by the identification information (UID). Since management information 140 on the users US0 sharing the printing device (200) is notified, the present aspect can provide a suitable printing system SY1 that manages the users US0 who share the printing device (200).

### Aspect 4

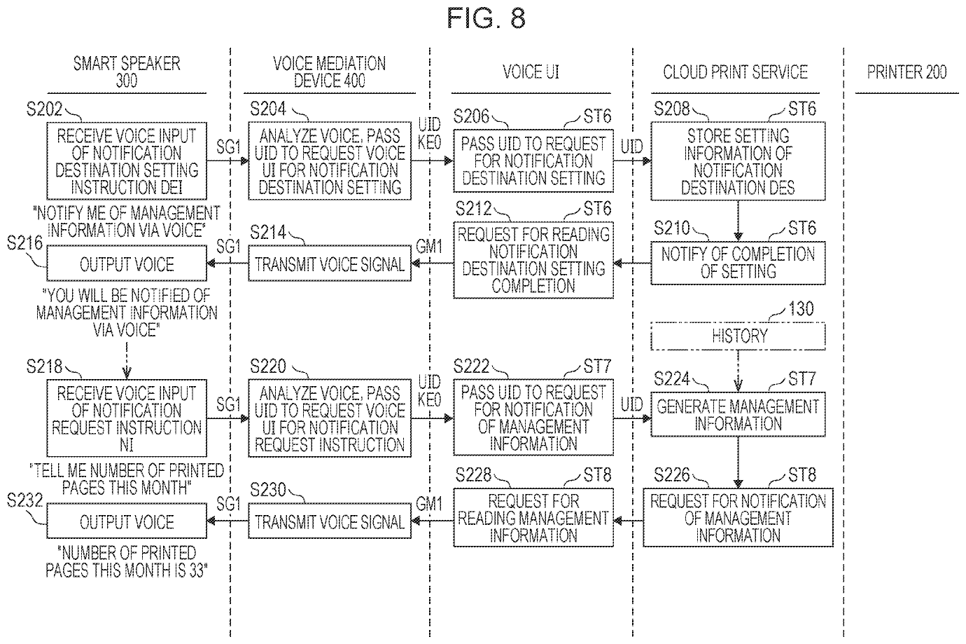

As illustrated in FIG. 8, the instruction may include a notification request instruction NI for requesting for notification of the management information 140. The management unit 122 may generate the management information 140 upon acquisition of the notification request instruction NI by the instruction acquisition unit 111 as a trigger. Since the management information 140 can be quickly obtained by a verbal notification request instruction NI, the present aspect can further improve the convenience of management of printing.

### Aspect 5

As illustrated in FIG. 8, the instruction acquisition unit 111 may acquire the notification request instruction NI, and the identification information (UID) of the user US0 from the voice mediation device 400. The management unit 122 may generate the management information 140 based on the history 130 associated with the acquired identification information (UID). Since the user US0 who has uttered the notification request instruction NI is notified of the management information 140 of the user US0, the present aspect can provide a suitable printing system SY1 to manage the printing.

### Aspect 6

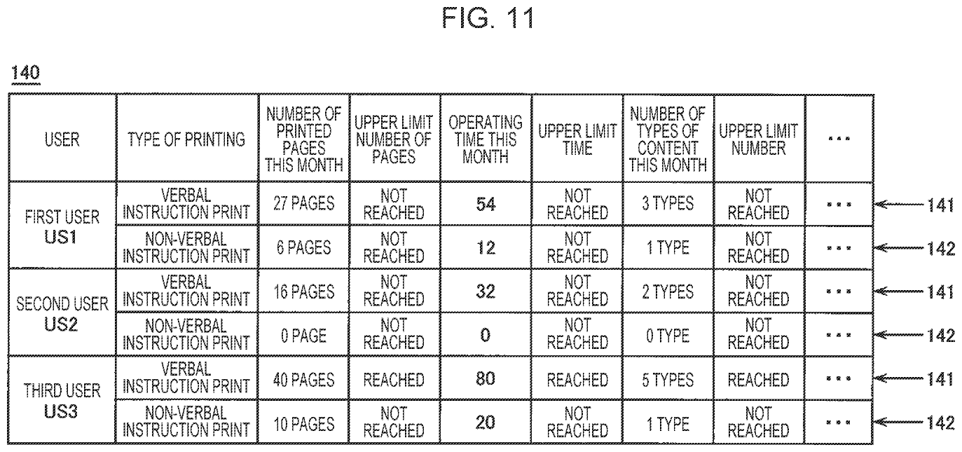

As illustrated in FIG. 3, the storage 121 may store a first history 131 and a second history 132 in association with the identification information (UID) of the user US0, the first history 131 being the history 130 of the print instruction PI verbally given by the user US0, the second history 132 being the history 130 of other print instructions PI non-verbally given by the user US0. As illustrated in FIG. 11, the management unit 122 may generate the management information 140 with the first history 131 and the second history 132 separated. The transmitter 124 may transmit the management information 140 to the notification destination DES with a first section 141 based on the first history 131 and a second section 142 based on the second history 132 separated. Since it is possible to separately obtain the first section 141 based on the history 130 of verbal print instruction PI, and the second section 142 based on the history 130 of non-verbal print instruction PI of the management information 140, the present aspect can further improve the convenience of the printing system SY1.

### Aspect 7

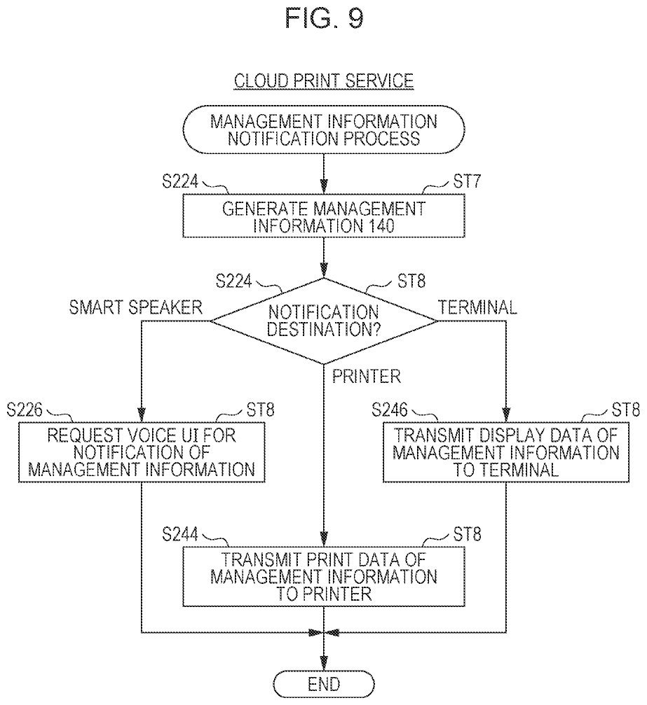

As illustrated in FIGS. 8 and 9, the notification destination DES may include a voice I/O device (300) connected to the voice mediation device 400 via the network NE1. The transmitter 124 may request the voice mediation device 400 to read out the management information 140 by the voice I/O device (300). Since the user US0 can be informed of the management information 140 by voice, the present aspect can further improve the convenience of management of printing.

### Aspect 8

As illustrated in FIG. 9, the notification destination DES may include the printing device (200). The transmitter 124 may transmit the management information 140 to the printing device (200). The printing device (200) receives the management information 140, and may print the management information 140. Thus, even when the management information 140 includes much information, the user US0 can easily identify the management information 140 by viewing the printed material 600 of the management information 140. Consequently, the present aspect can provide the printing system SY1 that allows the user US0 to easily identify the management information 140.

### Aspect 9

As illustrated in FIGS. 1 and 9, the notification destination DES may include a terminal 500 connected to the server 100 via the network NE1. The transmitter 124 may transmit the generated management information 140 to the terminal 500. Since the management information 140 can be identified by the terminal 500 other than the voice I/O device (300) and the printing device (200), the present aspect can further improve the convenience of management of printing.

### Aspect 10

As illustrated in FIGS. 8 and 9, the transmitter 124 receives the setting for the notification destination DES, and may transmit the management information 140 to the notification destination DES with the received setting. Since the user US0 can obtain the management information 140 at a desired notification destination DES, the present aspect can further improve the convenience of management of printing.

### Aspect 11

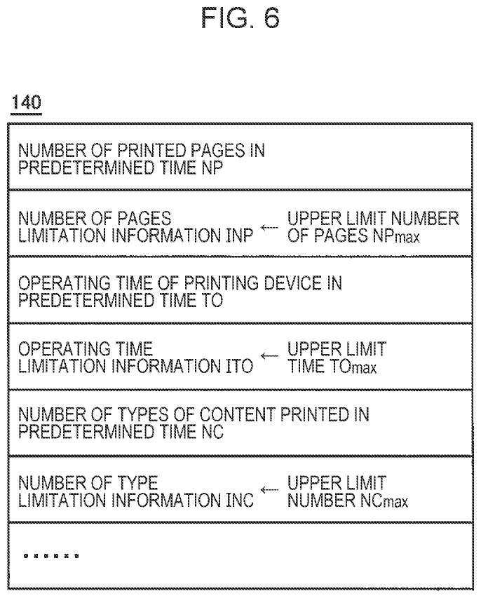

As illustrated in FIGS. 6 and 10, the management unit 122 may generate the management information 140 based on the history 130 associated with the identification information (UID), the management information 140 including at least one of the number of printed pages NP of the printed material 600 produced by the user US0 in a predetermined period, and the number of page limitation information INP which indicates whether the number of pages NP has reached an upper limit number NPmax. The transmitter 124 may transmit to the notification destination DES the management information 140 including at least one of the number of printed pages NP and the number of page limitation information INP. Since the user US0 can obtain at least one of the number of printed pages NP in a predetermined period and the number of page limitation information INP, the present aspect can further improve the convenience of management of printing.

### Aspect 12

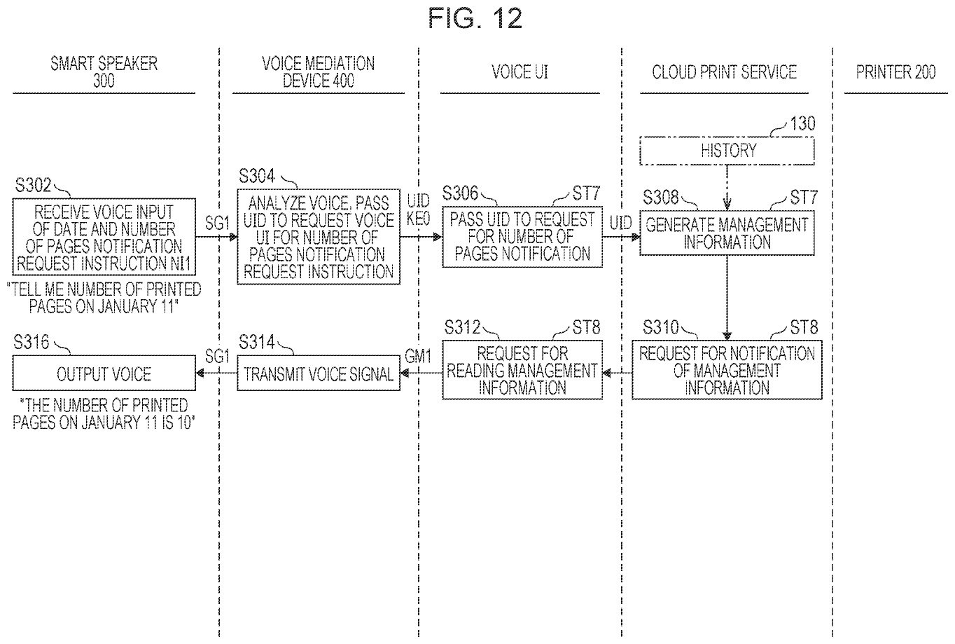

As illustrated in FIG. 12, the instruction may include a date. Furthermore, the instruction may include a number of page notification request instruction NI1 for requesting notification of the management information 140 including at least one of the number of printed pages NP of the printed material 600 produced by the user US0 on the date, and the number of page limitation information INP which indicates whether the number of pages NP has reached the upper limit number NPmax. The management unit 122 may generate the management information 140 including at least one of the number of printed pages NP and the number of page limitation information INP based on the history 130 associated with the identification information (UID). The transmitter 124 may transmit the management information 140 including at least one of the number of printed pages NP and the number of page limitation information INP to the notification destination DES. Since the user US0 can obtain at least one of the number of printed pages NP and the number of page limitation information INP on the date requested by the user US0, the present aspect can further improve the convenience of management of printing.

### Aspect 13

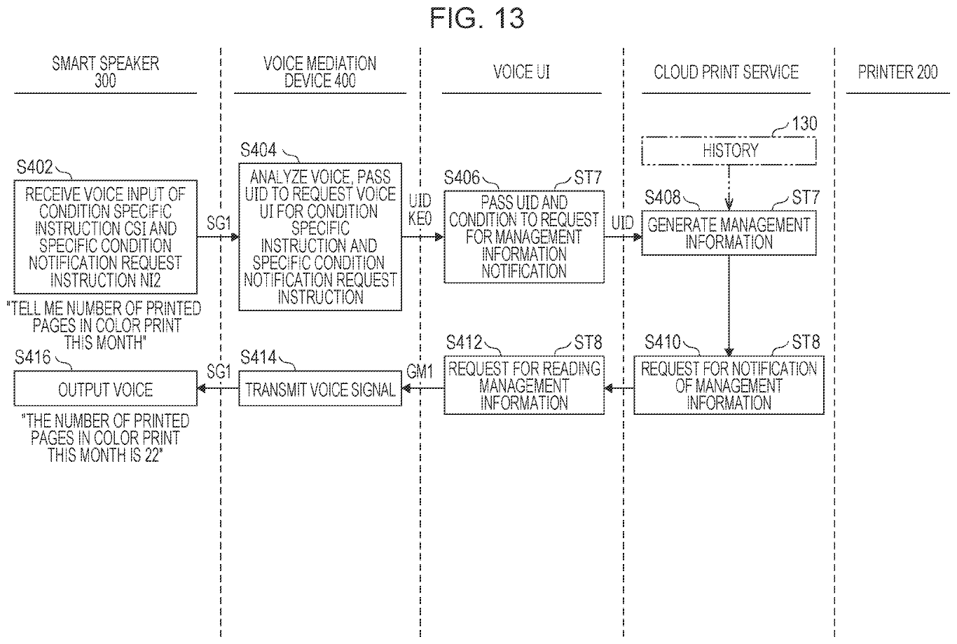

As illustrated in FIG. 3, the history 130 may include one or more print settings, and a print condition 730 including print setting values corresponding to the print settings. As illustrated in FIG. 13, the notification request instruction NI may include a condition specific instruction CSI to specify the print settings, and a specific condition notification request instruction NI2 to request for notification of the print setting values corresponding to the specified print settings. The management unit 122 may generate notification information including the specified print settings and the print setting values as the management information 140 based on the specific condition notification request instruction NI2. The transmitter may transmit the notification information to the notification destination DES. Since the user US0 can obtain the management information 140 matching the print condition 730 specified by the user US0, the present aspect can further improve the convenience of management of printing.

### Aspect 14

As illustrated in FIGS. 6 and 10, the management unit 122 may generate management information 140 based on the history 130 associated with the identification information (UID), the management information 140 including at least one of an operating time TO during which the printing device (200) is operated by the user US0 in a predetermined period, and an operating time limitation information ITO which indicates whether the operating time TO has reached an upper limit time TOmax. The transmitter 124 may transmit the management information 140 including at least one of the operating time TO and the operating time limitation information ITO to the notification destination DES. Since the user US0 can obtain at least one of the operating time TO in a predetermined period and the operating time limitation information ITO, the present aspect can further improve the convenience of management of printing.

### Aspect 15

As illustrated in FIGS. 6 and 10, the management unit 122 may generate management information 140 based on the history 130 associated with the identification information (UID), the management information 140 including at least one of the number of types NC of the content CO2 printed by the user US0 in a predetermined period, and a number of type limitation information INC which indicates whether the number of types NC has reached an upper limit number NCmax. The transmitter 124 may transmit the management information 140 including at least one of the number of types NC and the number of type limitation information INC to the notification destination DES. Since the user US0 can obtain at least one of the number of types NC of the content CO2 printed by the user US0 in a predetermined period, and the number of type limitation information INC, the present aspect can further improve the convenience of management of printing.

### Aspect 16

The server 100 according to an aspect of the present technique is connected via the network NE1 to the printing device (200) that performs printing in accordance with received data, and includes an instruction acquisition unit 111, a transmitter 124, a storage 121, and a management unit 122. The instruction acquisition unit 111 acquires from the voice mediation device 400 an instruction verbally given by the user US0, the instruction including a print instruction PI. The transmitter 124 transmits print data DA1 based on the acquired print instruction PI to the printing device (200). The storage 121 stores history 130 of printing based on the print instruction PI in association with the identification information (UID) of the user US0. The management unit 122 generates management information 140 to manage the printing by the user US0 based on the history 130 associated with the identification information (UID). The transmitter 124 transmits the generated management information 140 to the notification destination DES. Consequently, the user US0 can obtain the number of printed pages, thus the present aspect can provide the server 100 that improves the convenience of management of printing. Note that the above-described aspects 2 to 15 can be added to the above-described aspect 16.

Furthermore, the present technique is applicable to a compound system including the above-described printing system SY1, a compound device including the above-described server 100, a printing method performed by the above-described printing system SY1, a print control method performed by the above-described server 100, a print program that causes a computer to implement respective functions corresponding to the components of the above-described printing system SY1, a print control program PR1 that causes a computer to implement respective functions corresponding to the components of the above-described server 100, and a computer-readable medium on which the above-described program is recorded.

### 2. Specific Example of Configuration of Printing System

FIG. 1 schematically illustrates the configuration of a system including the printing system SY1. The system illustrated in FIG. 1 includes a server 100, a printer 200, a smart speaker 300, a voice mediation device 400 and a terminal 500. The printing system SY1 includes the server 100 and the printer 200. The user US0 can directly operate the printer 200, the smart speaker 300, and the terminal 500. The printer 200, the smart speaker 300, and the terminal 500 may be shared by multiple users, such as a first user US1, and a second user US2, for example. In this case, the user US0 collectively refers to the first user US1, and the second user US2. The server 100, the printer 200, the smart speaker 300, the voice mediation device 400, and the terminal 500 are connected to a network NE1 including the Internet. The network NE1 including the Internet may include a LAN. Here, LAN is an abbreviation of Local Area Network. The connection to the network NE1 may be a wired connection, a wireless connection, or both wired and wireless connection. The server 100 is a server computer that provides a function called a cloud print service, and provides a function called voice UI to the voice mediation device 400. Here, UI is an abbreviation of user interface. At the time of printing the content CO2, the server 100 transmits to the printer 200 the print data DA1 based on a keyword KE0 from the voice mediation device 400. The printer 200 is a printing device that forms a print image IM1 in accordance with the print data DA1 from the server 100. The smart speaker 300 is a voice I/O device using the function called a voice recognition service by the voice mediation device 400. The voice mediation device 400 is a server computer that provides a voice recognition service utilizing AI. Here, AI is an abbreviation of artificial intelligence.

In the following description, “voice UI” refers to a functional unit of the server 100, which implements a function called voice UI, and “cloud print service” refers to a functional unit of the server 100, which implements a function called a cloud print service. The keyword KE0 may be a term used for identifying target records, and is not limited to a word, and may be a phrase or a clause.

The server 100 has a voice UI area 110 which is a storage area for information to implement the voice UI, and a print service area 120 which is a storage area for information to implement the cloud print service. The voice UI is a service built on the platform of the voice recognition service by a provider of the cloud print service. The voice UI area 110 includes an information area to implement the print instruction acquisition unit 111. The print service area 120 includes an information area to implement a storage 121, a management unit 122, and a transmitter 124. The storage 121 stores multiple pieces of printable content CO1, and further stores the history 130 of printing based on the print instruction PI verbally given by the user US0. The server 100 executes multiple processes concurrently to implement the voice UI and the cloud print service. Note that the voice UI and the cloud print service may be built on separate computers. In addition, the voice UI may be built on a server computer which provides a voice recognition service.

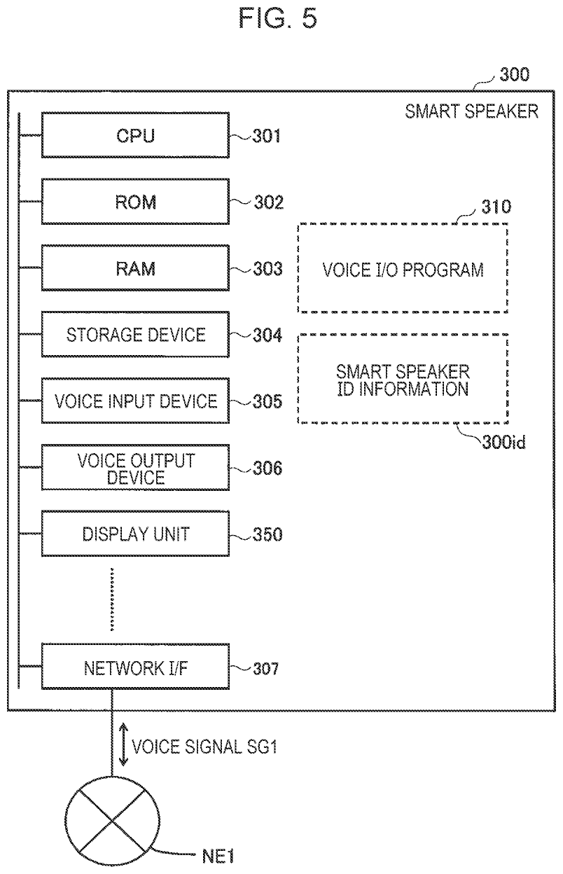

For example, when the user US0 utters “Print staff notation”, the smart speaker 300 converts the voice from the user US0 into a digital audio signal SG1, and transmits the audio signal SG1 to the voice mediation device 400 via the network NE1. After receiving the audio signal SG1, the voice mediation device 400 acquires the identification information of the user US0, and analyzes the voice based on the digital audio signal SG1. When the voice contains a print request keyword which is a type of keyword KE0, such as “Print . . . ”, the voice mediation device 400 requests the voice UI for printing, and passes the identification information of the user US0, and keyword KE0 such as “staff notation” contained in the voice to the voice UI. The voice mediation device 400 receives smart speaker identification information 300id illustrated in FIG. 5 from the smart speaker 300, and may acquire identification information of the user US0 associated with the smart speaker identification information 300id. The voice mediation device 400 may identify the user US0 based on the digital audio signal SG1, and may acquire the identification information of the identified user US0. Of “Print Request {userID} {StaffNotation}” illustrated in FIG. 1, “{userID}” indicates the identification information of the user US0, and “StaffNotation” indicates keyword KE0 such as “staff notation”. After receiving the identification information and the keyword KE0 along with the print request keyword, the voice UI performs a process according to the keyword KE0. The voice UI sends a print request for the content CO2 identified by the keyword KE0 among the printable content CO1 to the cloud print service. The printable contents CO1 is stored in the storage 121 or an external server computer which is not illustrated.

After receiving the print request, the cloud print service generates print data DA1 using the content CO2, and transmits the print data DA1 to the printer 200 associated with the identification information of the user US0 via the network NE1. After receiving the print data DA1, the printer 200 performs printing in accordance with the print data DA1, and produces the printed material 600 with print image IM1 based on the print data DA1 formed on print substrate ME1. Thus, the content CO2 of “staff notation” uttered by the user US0 is printed. Note that not only a print target, but also the printer 200, which is assumed to be an output destination by the user US0, may also be designated with the keyword KE0 by saying “Print staff notation using company A printer”. The print request keyword is not limited to “Print . . . ”, and may include similar variations, such as “Perform printing of . . . ”. Thus, for voice including these variations, the server 100 may perform a process similar to the process for voice including the print request keyword “Print . . . ”.

The voice UI performs a process of transmitting a guidance message GM1 such as “Staff notation has been printed” to the voice mediation device 400. After receiving the guidance message GM1, the voice mediation device 400 converts the guidance message GM1 into a digital audio signal SG1, and transmits the converted digital audio signal SG1 to the smart speaker 300 via the network NE1. After receiving the audio signal SG1, the smart speaker 300 converts the audio signal SG1 to voice, and outputs voice, such as “Staff notation has been printed”.

The cloud print service of the specific example stores in the storage 121 history 130 of printing based on the print instruction PI in association with user ID information UID which is the identification information of the user US0, and notifies the notification destination DES of the management information 140 according to a notification request instruction from the user US0. The management information 140 is for managing printing by the user US0, and includes the history 130. The user US0 can receive notification of the management information 140 at a defined notification destination DES by uttering a notification request instruction to request for notification of the management information 140. The notification destination DES includes the printer 200, the smart speaker 300 connected to the voice mediation device 400 via the network NE1, and the terminal 500 connected to the server 100 via the network NE1. The notification destination DES is notified of the management information 140, thereby making it possible for the user US0 to manage the verbal instruction print.

FIG. 2 schematically illustrates the configuration of the server 100. The server 100 illustrated in FIG. 2 is a single server computer having the voice UI area 110 and the print service area 120; however, the server 100 may be comprised of multiple server computers connected to each other. For example, the server 100 may have a configuration in which a server computer having the voice UI area 110 and a server computer having the print service area 120 are separately provided. In addition, the voice UI area 110 may be built on a server computer which provides a voice recognition service, and even in this case, the server 100 including the voice UI area 110 and the print service area 120 is comprised.

The server 100 illustrated in FIG. 2 includes a CPU 101 serving as a processor, a ROM 102 serving as a semiconductor memory, a RAM 103 serving as a semiconductor memory, a storage device 104, an input device 105, a display device 106, a network I/F 107, and a clock circuit 108. These components are electrically coupled, thereby making it possible to input and output information to and from each other. Here, CPU is an abbreviation of Central Processing Unit, ROM is an abbreviation of Read Only Memory, RAM is an abbreviation of Random Access Memory, and I/F is an abbreviation of interface.

The storage device 104 stores an OS which is not illustrated, and has the above-described voice UI area 110, and print service area 120. Here, OS is an abbreviation of operating system. The voice UI area 110 stores a program which causes the server 100 to implement an instruction acquisition function FU1. The print service area 120 has the storage 121 storing the history 130 and the printable content CO1, and stores programs which cause the server 100 to implement a management function FU2 and a transmission function FU4. The print control program PR1 includes programs which cause the server 100 to implement the above-mentioned functions. The information stored in the storage device 104 is read into the RAM 103 as appropriate, and is used for a process for causing the printer 200 to perform printing. A magnetic storage device such as a hard disk, or a nonvolatile semiconductor memory such as a flash memory may be used as the storage device 104. Note that the print control program PR1 may be called a print application from the viewpoint of the user US0.

As the input device 105, a pointing device, a hard key including a keyboard, or a touch panel applied to the surface of a display panel may be used. A liquid crystal display panel or the like may be used as the display device 106. The network I/F 107 is connected to the network NE1, and communicates with the devices connected to the network NE1 in accordance with a predetermined communication standard. The clock circuit 108 can output the current date and time.

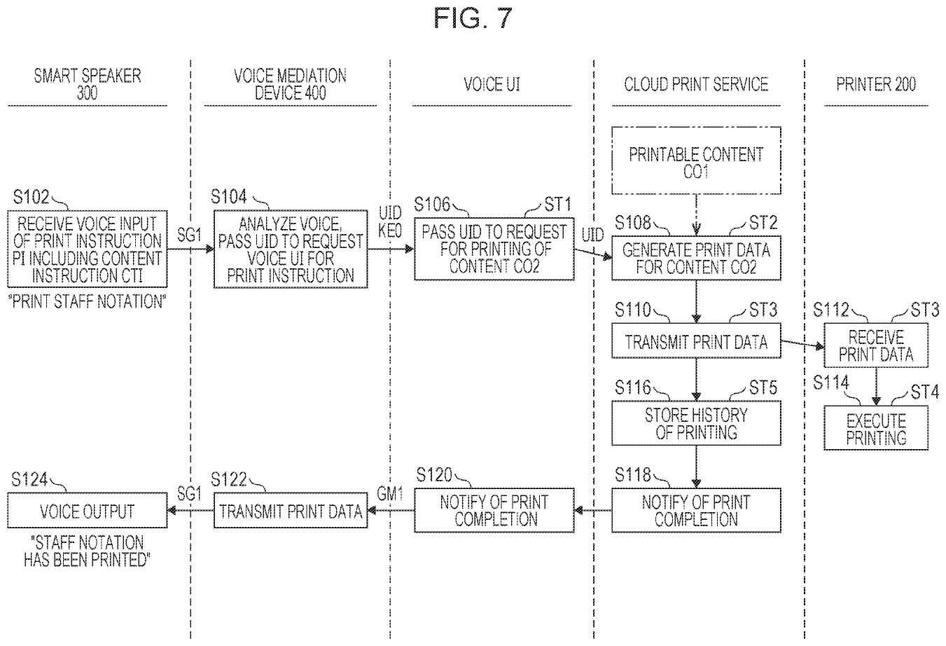

The CPU 101 executes the print control program PR1 which is read from the storage device 104 into the RAM 103, thereby performing an instruction acquisition process corresponding to the instruction acquisition function FU1, a management process corresponding to the management function FU2, and a print data transmission process corresponding to the transmission function FU4. The print control program PR1 causes the server 100 to function as the print instruction acquisition unit 111 corresponding to the instruction acquisition function FU1, the management unit 122 corresponding to the management function FU2, and the transmitter 124 corresponding to the transmission function FU4, the server 100 being a computer. As illustrated in FIGS. 7 to 9, the server 100 executing the print control program PR1 performs a print instruction acquisition step ST1, a print data generation step ST2, a print data transmission step ST3, a print step ST4, a storing step ST5, a notification destination setting step ST6, a management information generation step ST7, and a management information notification step ST8. The computer-readable medium storing the print control program PR1 is not limited to the storage device 104, and may be a recording medium outside the server 100.

FIG. 3 schematically illustrates the structure of the history 130 of printing stored in the storage 121. The history 130 illustrated in FIG. 3 is managed in account information 700 including account ID information AID, transmission destination 710 of print data DA1, and user ID information UID. The account ID information AID is information to identify the accounts for one or more users. Each of the accounts is assigned an account name which is not illustrated. The account name and the account ID information AID are information to authenticate a user using the account. The transmission destination 710 is indicated by information which identifies the printer 200. FIG. 3 shows that account ID information “AID1” is associated with transmission destination “PRT1”, account ID information “AID2” is associated with transmission destination “PRT2”, and account ID information “AID3” is associated with transmission destination “PRT3”. Note that one piece of account ID information AID may be associated with multiple transmission destinations 710. Each account ID information AID is associated with one or more pieces of user ID information UID. For example, account ID information “AID1” is associated with “UID11”, “UID12”, and “UID13” as the user ID information UID. This means that there are three users utilizing the account specified by the account ID information “AID1”. It may be stated that the user ID information UID is associated with the account information 700.

In the history 130 illustrated in FIG. 3, the account information 700 is associated with an instruction source 720 of print instruction, content ID information CID, a print condition 730, a number of printed pages NP, an operating time TO of the printer 200, and print date/time. The instruction source 720 includes the smart speaker 300 indicated by “voice,” and the terminal 500 indicated by “terminal”. The content ID information CID is information to identify the content CO2 to be printed. In FIG. 3, for convenience, a content name, such as “staff notation”, is shown as content ID information CID. The print condition 730 includes the size of print substrate ME1 color selection between monochrome print and color print, selection between single sided printing and double sided printing, selection as to whether borderless printing is applied or not, and image quality selection between high image quality, normal image quality, and high-speed printing. The number of printed pages NP is the number of printed materials 600 produced. The operating time TO is the time during which the printer 200 was operated to produce the printed material 600, and may be expressed in terms of second, or in terms of minute. The history 130 may store a converted value of the power consumption of the printer 200, instead of the operating time TO. Each time print data DA1 is transmitted, the combination of the instruction source 720, the content ID information CID, the print condition 730, the number of printed pages NP, the operating time TO, and the print date/time is added to the history 130 in association with the user ID information UID. For the sake of convenience, the history 130 of print instruction PI verbally given by the user US0 is referred to as a first history 131, and the history 130 of print instruction PI non-verbally given by the user US0 is referred to as a second history 132.

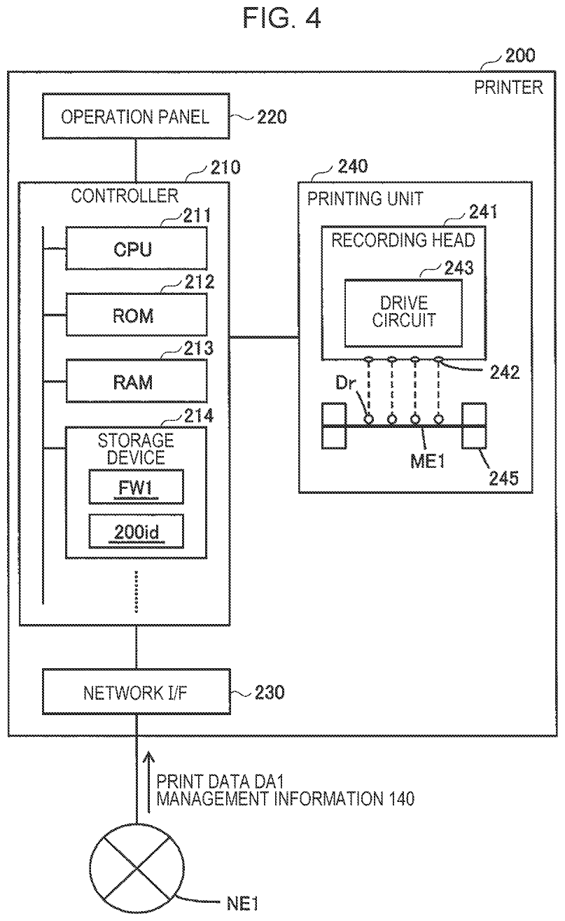

FIG. 4 schematically illustrates the configuration of the printer 200. The printer 200 illustrated in FIG. 4 is a printing device that can print the content CO2 in accordance with the print data DA1 received via the network NE1. The printer 200 of this specific example can print the management information 140 in accordance with the management information 140 received via the network NE1. The printer 200 usable for the printing system SY1 is not particularly limited, and may be an ink jet printer, or an electrophotographic printer such as a laser printer. The printer 200 may be a copier, a facsimile, or a multifunctional device having these functions. FIG. 4 illustrates the configuration of the printer 200 which is an ink jet printer.

The printer 200 illustrated in FIG. 4 has a controller 210, an operation panel 220, a network I/F 230, and a print unit 240. The controller 210 includes a CPU 211, a ROM 212, a RAM 213, and a storage device 214. These components are electrically coupled, thereby making it possible to input and output information to and from each other. In other words, the printer 200 is a type of a computer. The storage device 214 stores a firmware FW1 causing a computer to function as the printer 200, and printer ID information 200id to identify the printer 200 individually. An email address, an IP address, and a serial number may be used as the printer ID information 200id. Here, the IP address is an abbreviation of Internet Protocol Address. A nonvolatile semiconductor memory such as a flash memory, and a magnetic storage device such as a hard disk may be used as the storage device 214.

The operation panel 220 includes a display unit and an operation input which are not illustrated, and receives an operation performed by the user US0. The display unit is comprised of, for example, a liquid crystal panel, and displays information indicating the state of the printer 200, and information indicating an instruction by the user US0. The operation input is comprised of, for example, multiple operation keys including cursor keys and the enter key. The operation input may be a touch panel that receives an operation to the display screen. The network I/F 230 is connected to the network NE1, and communicates with the devices connected to the network NE1 in accordance with a predetermined communication standard.

The print unit 240 has a recording head 241 that discharges droplets Dr, such as ink drop, to a print substrate, and a paper feeder 245 that transports the print substrate ME1. The recording head 241 has multiple nozzles 242 through which the droplets Dr are discharged, and a drive circuit 243 that ejects the droplets Dr through the nozzles 242. As the drive circuit 243, it is possible to use a circuit that drives a piezoelectric element to apply a pressure to the liquid in pressure chambers communicating with the nozzles 242, and a circuit that drives a thermal element to generate air bubbles by heat in the liquid of each pressure chamber. The droplets Dr hit the print substrate ME1 transported by the paper feeder 245, thus a print image IM1 corresponding to the print data DA1 from the server 100 is formed on the print substrate ME1. Note that the print substrate ME1 is a material which holds print images IM1. It is possible to use paper, resin, and metal as the print substrate. The shape of the print substrate ME1 is generally a rectangular shape or a roll shape, but may be a substantially circular shape such as an optical disk shape, a polygonal shape other than a rectangular shape, or a three-dimensional shape.

FIG. 5 schematically illustrates the configuration of the smart speaker 300 utilizing the voice recognition service provided by the voice mediation device 400. The smart speaker 300 illustrated in FIG. 5 has a CPU 301, a ROM 302, a RAM 303, a storage device 304, a voice input device 305, a voice output device 306, a network I/F 307, and a display unit 350. These components are electrically coupled, thereby making it possible to input and output information to and from each other. In other words, the smart speaker 300 is a type of a computer. The storage device 304 stores a voice I/O program 310 causing a computer to function as the smart speaker 300, and smart speaker ID information 300id to identify the smart speaker 300 individually. A nonvolatile semiconductor memory such as a flash memory, and a magnetic storage device such as a hard disk may be used as the storage device 304. The display unit 350 is comprised of, for example, a liquid crystal panel, and displays information indicating the state of the smart speaker 300. Note that the smart speaker 300 does not need to include the display unit 350.

The voice input device 305 has a microphone, converts the voice input from the outside into an analog electrical signal by the microphone, and converts the analog electrical signal into a digital audio signal SG1. The number of the voice input devices 305 provided in the smart speaker 300 may be one, or greater than or equal to two. The voice output device 306 has a speaker in a narrow sense, which converts an analog electrical signal into sound. The voice output device 306 converts the digital audio signal SG1 into an analog electrical signal, converts the analog electrical signal into voice by the speaker, and outputs the voice to the outside. The number of the voice output devices 306 provided in the smart speaker 300 may be one, or greater than or equal to two. The network I/F 307 is connected to the network NE1, and communicates with the devices connected to the network NE1 in accordance with a predetermined communication standard. The smart speaker 300 of this specific example can output the management information 140 via voice to the outside according to the audio signal SG1 indicated by the management information 140, and can display the management information 140 on the display unit 350 according to the display data of the management information 140.

The voice mediation device 400 illustrated in FIG. 1 is a server computer, and has, for example, a CPU, a ROM, a RAM, a storage device, an input device, a display device, and a network I/F. It is possible to use a mobile terminal, such as a smartphone or a tablet terminal, and a personal computer as the terminal 500 illustrated in FIG. 1. The terminal 500 has, for example, a CPU, a ROM, a RAM, a storage device, an input device, a display device, and a network I/F. The terminal 500 of this specific example can display the management information 140 on the display device according to the display data of the management information 140, and can output the management information 140 via voice to the outside according to the audio signal indicated by the management information 140.

FIG. 6 schematically illustrates an example of the management information 140. The management information 140 includes the following information.

(A) The number of printed pages NP of the printed material 600 produced by the user US0 in a predetermined period.
(B) The number of page limitation information INP which indicates whether the number of printed pages NP has reached an upper limit number NPmax.
(C) The operating time TO during which the printing device 200 is operated by the user US0 in a predetermined period.
(D) The operating time limitation information ITO which indicates whether the operating time TO has reached an upper limit time TOmax.
(E) The number of types NC of the content CO2 printed by the user US0 in a predetermined period.
(F) The number of type limitation information INC which indicates whether the number of types NC has reached an upper limit number NCmax.

In addition, the management information 140 may include a converted value of the electric power consumed by the printer 200 used by the user US0 in a predetermined period. The present technique also includes the case where part of the above-described information (A) to (F) is not generated. For example, information (A) may not be generated while information (B) is generated, or information (B) may not be generated while information (A) is generated. Information (C) may not be generated while information (D) is generated, or information (D) may not be generated while information (C) is generated. In addition, information (E) may not be generated while information (F) is generated, or information (F) may not be generated while information (E) is generated.

### 3. Specific Example of Process of System

FIG. 7 schematically illustrates a process of printing the content CO2 by voice input. As described above, the “voice UI” refers to a functional unit of the server 100, which implements the function called the voice UI, and the “cloud print service” refers to a functional unit of the server 100, which implements the function called the cloud print service. Here, step S106 corresponds to the print instruction acquisition step ST1, the print instruction acquisition unit 111, and the instruction acquisition function FU1. Step S108 corresponds to the print data generation step ST2. Step S108 to S110 correspond to the transmission function FU4 performed by the transmitter 124. Step S110 to S112 correspond to the print data transmission step ST3. Step S114 corresponds to the print step ST4. Step S116 corresponds to the storing step ST5. Hereinafter “step” is omitted, and a symbol for each step is shown in parentheses.

When the user US0 utters a print instruction PI including content instruction CTI to the smart speaker 300, the smart speaker 300 converts the voice from the user US0 into an audio signal SG1, and transmits the audio signal SG1 to the voice mediation device 400 (S102). The content instruction CTI shows the content CO2 specified from multiple printable contents CO1. For example, when the user US0 utters “Print staff notation”, “staff notation” serves as the content instruction CTI. As is illustrated in FIG. 3, the print instruction PI can include the print condition 730 and the number of print pages NP. When the print instruction PI includes no print condition 730, the content CO2 is printed according to the print condition 730 already set. When the print instruction PI does not include the number of printed pages NP, the content CO2 is printed with the number of print pages NP already set.

After receiving the audio signal SG1, the voice mediation device 400 acquires the user ID information UID to identify the user US0, analyzes the voice based on the audio signal SG1, extracts each keyword KE0 from results of the analysis of the voice, and passes the user ID information UID and the keyword KE0 to the voice UI to request for a print instruction PI (S104). The print instruction PI includes a content instruction CTI. The keyword KE0 is included in the verbal print instruction PI. The print instruction PI may include a keyword which identifies the printer 200.

The voice mediation device 400 stores the identification information of each user US0 in the storage device, and stores smart speaker ID information 300id in association with the identification information of the user US0. Thus, when the smart speaker 300 transmits the smart speaker identification information 300id, the voice mediation device 400 can acquire the identification information of the user US0 associated with the smart speaker identification information 300id. In addition, the voice mediation device 400 stores information indicating the characteristics of the voice of the user US0 in the storage device in association with the identification information of the user US0. The characteristics of the voice to identify the user US0 can be expressed by the frequency distribution of the voice, for example. Thus, the voice mediation device 400 determines the frequency distribution of the voice based on the audio signal SG1, and may acquire from the storage device the identification information of the user US0 associated with a frequency distribution closest to the above-mentioned frequency distribution. Furthermore, the smart speaker 300 receives a voice input of the name of the user US0, and the voice mediation device 400 may extract the name of the user US0 based on the audio signal SG1 to acquire the identification information of the user US0 associated with the name from the storage device.

When acquiring the print instruction PI including the above-mentioned keyword KE0 from the voice mediation device 400, the voice UI passes the user ID information UID to the cloud print service, and requests for generation of the print data DA1 of the content CO2 (S106). In this manner, the instruction acquisition unit 111 of the server 100 acquires print instruction PI verbally given by the user US0 from the voice mediation device 400, the print instruction PI including a content instruction CTI indicating the content CO2 as a print target. The user ID information UID passed to the cloud print service may be information showing the user US0 indicated by the user ID information UID passed from the voice mediation device 400, and data may be changed from the user ID information UID passed from the voice mediation device 400.

After receiving a request from the voice UI, the cloud print service generates print data DA1 using the content CO2 requested from the voice UI (S108). The print data DA1 is for causing the printer 200 to print the content CO2 based on the print instruction PI among the printable content CO1. When the print instruction PI includes a print condition 730, print data DA1 is generated according to the print condition 730, and when the print instruction PI includes no print condition 730, print data DA1 is generated according to the print condition 730 already set. When the print instruction PI includes the number of printed pages NP, print data DA1 for content CO2 with the number of printed pages NP is generated, and when the print instruction PI does not include the number of printed pages NP, print data DA1 for content CO2 with the number of printed pages NP already set is generated. After the print data DA1 is generated, the cloud print service transmits the print data DA1 via the network NE1 to the printer 200 at the transmission destination 710 indicated by the account information 700 as illustrated in FIG. 3 (S110). For example, the cloud print service transmits the print data DA1 to the printer 200 at the transmission destination 710 associated with the user ID information UID via the account ID information AID in the account information 700 associated with the user ID information UID. As described above, the transmitter 124 of the server 100 transmits to the printer 200 of the relevant user US0 the print data DA1 based on the print instruction PI including the content instruction CTI.

The printer 200 receives the print data DA1 via the network NE1 (S112), and performs printing in accordance with the print data DA1 (S114). Thus, the content CO2 according to the utterance of the user US0 is printed.

In addition, the cloud print service stores the history 130 of printing based on the print instruction PI in association with the user ID information UID (S116). For example, in the history 130 illustrated in FIG. 3, a print instruction PI is given from the user US0 with the user ID information “UID11”, the print instruction PI being issued on January 14 by “voice A” for five sheets of “notebook guidelines” in the print condition of “A4 monochrome printing”. In this case, the instruction source of “voice A,” the content ID information of “notebook guidelines”, the print condition of “A4 monochrome printing”, the number of printed pages of “5”, the printer 200 operating time of “10”, and the print date/time are added to the history 130 in association with the user ID information “UID11”. The user ID information UID stored in the history 130 may be information showing the user US0 indicated by the user ID information UID passed from the voice UI, and data may be changed from the user ID information UID passed from the voice UI.

After transmission of print data and storing of history, the cloud print service sends to the voice UI a notification of completion of printing of the relevant content CO2 (S118). After receiving the notification of completion of printing, the voice UI requests the voice mediation device 400 to read out the name of the content CO2 as well as a print completion message such as “ . . . has been printed” as the guidance message GM1 (S120). After receiving the guidance message GM1, the voice mediation device 400 converts the guidance message GM1 into an audio signal SG1, and transmits the audio signal SG1 to the smart speaker 300 via the network NE1 (S122). After receiving the audio signal SG1, the smart speaker 300 converts the audio signal SG1 into voice, and outputs the voice (S124). Thus, the user US0 can hear the voice of the guidance message, such as “The staff notation has been printed”.

As illustrated in FIG. 8, the printing system SY1 can receive the setting of a notification destination DES via voice, and notify of the management information 140. FIG. 8 schematically illustrates a process of setting the notification destination DES and notifying of the management information 140. Here, S206 to S212 correspond to the notification destination setting step ST6. S222 to S224 correspond to the management information generation step ST7. S226 to S228 correspond to the management information notification step ST8. S206 and S222 correspond to the instruction acquisition function FU1 performed by the instruction acquisition unit 111. S208 to S210, S226 correspond to the transmission function FU4 performed by the transmitter 124. S224 corresponds to the management function FU2 performed by the management unit 122.

When the user US0 utters a notification destination setting instruction DEI to the smart speaker 300, the smart speaker 300 converts the voice from the user US0 into an audio signal SG1, and transmits the audio signal SG1 to the voice mediation device 400 (S202). For example, when the user US0 utters “Notify me of the management information via voice”, “management information” and “notify” are each used as a notification destination setting request keyword which is a type of keyword KE0, and “via voice” is used as a keyword KE0 showing the notification destination DES.

After receiving the audio signal SG1, the voice mediation device 400 acquires the user ID information UID, analyzes the voice based on the audio signal SG1, extracts each keyword KE0 from results of the analysis of the voice, and passes the user ID information UID and the keyword KE0 to the voice UI to request for setting of the notification destination DES (S204). When acquiring the keyword KE0 as the notification destination setting instruction DEI from the voice mediation device 400, the voice UI passes the user ID information UID to the cloud print service, and requests for setting of the notification destination DES (S206). After receiving the request from the voice UI, the cloud print service stores setting information showing the notification destination DES in the storage 121 in association with the user ID information UID (S208). For example, when keyword KE0 showing the notification destination DES is “via voice”, the cloud print service stores setting information indicating the smart speaker 300, thereby setting the notification destination DES in the smart speaker 300. When keyword KE0 showing the notification destination DES is “by a printer”, the cloud print service stores setting information indicating the printer 200, thereby setting the notification destination DES to the printer 200. When keyword KE0 showing the notification destination DES is “by a terminal”, the cloud print service stores setting information indicating the terminal 500, thereby setting the notification destination DES to the terminal 500.

In this manner, the transmitter 124 of the server 100 receives the setting of the notification destination DES. Note that the cloud print service may receive the setting of the notification destination DES from the terminal 500 via the network NE1.

After setting the notification destination DES, the cloud print service sends to the voice UI a notification of completion of setting of the notification destination DES (S210). After receiving the notification of completion of setting, the voice UI requests the voice mediation device 400 to read out a notification destination setting completion message, such as “You will be notified of management information via voice” as the guidance message GM1 (S212). After receiving the guidance message GM1, the voice mediation device 400 converts the guidance message GM1 into an audio signal SG1, and transmits the audio signal SG1 to the smart speaker 300 (S214). After receiving the audio signal SG1, the smart speaker 300 converts the audio signal SG1 into voice, and outputs the voice (S216). Consequently, a notification destination setting completion message, such as “You will be notified of management information via voice” is read out by voice for the user US0. Subsequently, when the user US0 utters the voice of a notification request instruction NI, such as “Tell me the number of printed pages this month”, the processes in and after S218 are performed. The notification request instruction NI is an instruction to request notification of the management information 140, and is included in the instructions acquired from the voice mediation device 400.

When the user US0 utters a notification request instruction NI to the smart speaker 300, the smart speaker 300 converts the voice from the user US0 into an audio signal SG1, and transmits the audio signal SG1 to the voice mediation device 400 (S218). For example, when the user US0 utters “Tell me the number of printed pages this month”, “tell me” is used as a notification request keyword which is a type of keyword KE0, “the number of printed pages” is used as a keyword KE0 showing the management information 140, and “this month” is used as a keyword KE0 showing a predetermined period.

After receiving the audio signal SG1, the voice mediation device 400 acquires the user ID information UID, analyzes the voice based on the audio signal SG1, extracts each keyword KE0 from results of the analysis of the voice, and passes the user ID information UID and the keyword KE0 to the voice UI to request for a notification request instruction NI (S220). When acquiring the keyword KE0 as the notification request instruction NI along with the user ID information UID from the voice mediation device 400, the voice UI passes the user ID information UID to the cloud print service, and requests for notification of the management information 140 to manage the printing by the user US0 (S222). After receiving the request from the voice UI, the cloud print service generates management information 140 associated with the user ID information UID, based on the history 130 (S224). Thus, the management unit 122 of the server 100 generates the management information 140 upon acquisition of the notification request instruction NI by the instruction acquisition unit 111 as a trigger. The management information 140 includes the information as illustrated in FIG. 6.

For example, when the management information 140 requested is the number of printed pages NP in a predetermined period in “this month”, the cloud print service tallies the number of printed pages NP this month among the number of printed pages NP associated with the user ID information UID in the history 130 illustrated in FIG. 3. When the current month is January, in the example illustrated in FIG. 3, the total of the number of printed pages NP associated with the user ID information UID is 33.

After the management information 140 is generated, the cloud print service performs a process of notifying a notification destination DES of the management information 140, the notification destination DES being set in association with the user ID information UID (S226). Thus, the transmitter 124 of the server 100 notifies the notification destination DES of the management information 140 with generation of the management information 140 by the management unit 122 serving as a trigger. When setting information indicating the smart speaker 300 is stored as the notification destination DES in the storage 121, the cloud print service requests the voice UI for notification of the management information 140, such as “The number of printed pages this month is 33”. After receiving the request from the cloud print service, the voice UI requests the voice mediation device 400 to read out the management information 140, such as “The number of printed pages this month is 33” as the guidance message GM1 (S228). In this manner, the transmitter 124 of the server 100 requests the voice mediation device 400 to read out the management information 140 by the smart speaker 300.

After receiving the guidance message GM1, the voice mediation device 400 converts the guidance message GM1 into an audio signal SG1, and transmits the audio signal SG1 via the network NE1 to the smart speaker 300 which has received the notification request instruction NI (S230). After receiving the audio signal SG1, the smart speaker 300 converts the audio signal SG1 into voice, and outputs the voice (S232). Consequently, the management information 140, such as “The number of printed pages this month is 33” is read out by voice for the user US0.

In this manner, the notification destination DES is notified of the management information 140 to manage the printing by the user US0. Thus, wasted printing and excessive use of the printer 200 can be reduced. Therefore, this specific example can manage verbal instruction print, and can improve the convenience of management of printing. Since the user US0 can be informed of the management information 140 by voice, this specific example can improve the convenience of management of printing. Additionally, conversation using a registered user name can be made, thus more friendly conversation can be made in this specific example.

As illustrated in FIG. 9, the cloud print service can notify of the management information 140 via not only the smart speaker 300 but also via the printer 200 and the terminal 500. FIG. 9 schematically illustrates a management information notification process performed by the cloud print service. In this process, S242, S244, S246 are added to S224, S226 illustrated in FIG. 8. Here, S226, S242, S244, S246 correspond to the management information notification step ST8, and correspond to the transmission function FU4 performed by the transmitter 124.

When the cloud print service generates the management information 140 (S224), the processes are branched according to the notification destination DES which has been set (S242). When the smart speaker 300 is set as the notification destination DES, the cloud print service requests the voice UI for notification of the management information 140 (S226), and completes the management information notification process.

When the printer 200 is set as the notification destination DES, the cloud print service transmits the print data for the management information 140 to the printer 200 via the network NE1 (S244), and completes the management information notification process. Although not illustrated, the printer 200 receives the print data for the management information 140 via the network NE1, and prints the management information 140 in accordance with the print data. Consequently, the printed material 600 of the management information 140 is produced. When the management information 140 includes much information, it is difficult to identify the entire management information 140 just by read out of the management information 140. Since the management information 140 is printed, the user US0 can easily identify the entire management information 140 by viewing the printed material 600 of the management information 140.

When the terminal 500 is set as the notification destination DES, the cloud print service transmits the management information 140 to the terminal 500 via the network NE1 (S246), and completes the management information notification process. Although not illustrated, the terminal 500 receives the management information 140 via the network NE1, and displays the management information 140. The user US0 can easily identify the entire management information 140 by viewing the displayed management information 140. In addition, the terminal 500 may read out the management information 140. In this specific example, the management information 140 can be identified via the terminal 500 other than the smart speaker 300 and the printer 200, thus the convenience of checking the management information 140 can be improved.

In this manner, the transmitter 124 of the server 100 receives the setting of the notification destination DES in S208 illustrated in FIG. 8, and notifies the received notification destination DES of the management information 140. In this specific example, the user US0 can identify the management information 140 at a desired notification destination DES, thus the convenience of checking the management information 140 can be improved. Note that the cloud print service may receive notification request instruction NI from the terminal 500 via the network NE1, and may perform the processes in and after S224 of FIGS. 8 and 9.

FIG. 10 schematically illustrates the management information 140 output from the printer 200 and the terminal 500. For the output of the management information 140 illustrated in FIG. 10, in S224 illustrated in FIGS. 8 and 9, the cloud print service can generate management information 140 based on the history 130, the management information 140 being for managing the printing by the user US0 associated with each user ID information UID in association with the account information 700. In addition, in S226, S244, S246 illustrated in FIGS. 8 and 9, the cloud print service can notify the notification destination DES of each management information 140 generated. The management information 140 illustrated in FIG. 10 corresponds to the management information 140 illustrated in FIG. 6.

In the example illustrated in FIG. 3, let us assume that the first user US1 in user ID information “UID11” is the administrator of the account of the account ID information “AID1”. In this case, the cloud print service generates pieces of management information 140 based on respective pieces of information associated with user ID information “UID11”, “UID12”, “UID13”, and notifies a notification destination DES of the pieces of management information 140, where the notification destination DES has received setting from the first user US1.

For example, let us assume that the current month is January, the total number of printed pages in January in association with the ID information “UID11” of the first user US1 is 33, the total number of printed pages in January in association with the ID information “UID12” of the first user US2 is 16, and the total number of printed pages in January in association with the ID information “UID13” of the first user US3 is 50. The cloud print service tallies the number of printed pages NP of the printed material 600 produced by the first user US1, the second user US2, and the third user US3 in January based on the history 130. In this case, “the number of printed pages NP this month” produced by the first user US1 is 33, “the number of printed pages NP this month” produced by the second user US2 of the user ID information “UID12” is 16, and “the number of printed pages NP this month” produced by the third user US3 of the user ID information “UID13” is 50. Here, let us assume that the upper limit number NPmax of the number of printed pages of each user is 50. The cloud print service sets the number of page limitation information INP for the first, second users US1, US2 to “not reached” which indicates that the upper limit number NPmax is not reached, and sets the number of page limitation information INP for the third user US3 to “reached” which indicates that the upper limit number NPmax is reached.

Let us assume that the current month is January, the total operating time in January in association with the ID information “UID11” of the first user US1 is 66, the total operating time in January in association with the ID information “UID12” of the second user US1 is 32, and the total operating time in January in association with the ID information “UID13” of the third user US1 is 100. The cloud print service tallies the operating time TO for the printer 200 operated by the first to third users US1, US2, US3 in January based on the history 130 associated with each user ID information UID. In this case, “the operating time TO this month” of the first user US1 is 66, “the operating time TO this month” of the second user US2 of user ID information “UID12” is 32, and “the operating time TO this month” of the third user US3 of user ID information “UID13” is 100. Here, let us assume that the upper limit time TOmax of the operating time of each user is 100. The cloud print service sets the operating time limitation information ITO for the first, second users US1, US2 to “not reached” which indicates that the upper limit time TOmax is not reached, and sets the operating time limitation information ITO for the third user US3 to “reached” which indicates that the upper limit time TOmax is reached.

When the current month is January, the content CO2 associated with the user ID information “UID11” has four types, the content CO2 associated with the user ID information “UID12” has two types, and the content CO2 associated with the user ID information “UID13” has six types. The cloud print service tallies the number of types NC of content CO2 based on the history 130, the content CO2 being printed by the first user US1, the second user US2, the third user US3 in January. In this case, “the number of types NC of printed content this month” for the first user US1 has four types “the number of types NC of printed content this month” for the second user US2 of the user ID information “UID12” has two types, and “the number of types NC of printed content this month” for the third user US3 of the user ID information “UID13” has six types. Here, let us assume that the upper limit number NCmax of the number of types of content of each user US0 is six. The cloud print service sets the number of type limitation information INC of each of the first user US1 and the second user US2 to “not reached” which indicates that the upper limit number NCmax is not reached, and sets the number of type limitation information INC of the third user US3 to “reached” which indicates that the upper limit number NCmax is reached.

The user US0 is notified of the management information 140 illustrated in FIG. 10, thus can identify the number of printed pages NP in a predetermined period, the number of page limitation information INP regarding the number of printed pages NP, the operating time TO in a predetermined period, the operating time limitation information ITO regarding the operating time T0, the number of types NC of printed content in a predetermined period, and the number of type limitation information INC regarding the number of types NC of printed content. Thus, this specific example can improve the convenience of management of printing. In addition, since the management information 140 of the users US0 who share the printer 200 is notified, this specific example can manage the printing of the users US0 sharing the printer 200. For example, the administrator of the printer 200 can easily tell how long has each user US0 used the printer 200.

As illustrated in FIG. 3, in the storage 121 illustrated in FIGS. 1 and 2, the history 130 includes the first history 131 of print instruction PI verbally given by each user US0, and the second history 132 of print instruction PI non-verbally given by each user US0, and is stored in association with corresponding user ID information UID. Thus, the cloud print service can notify of the management information 140 based on the first history 131 and the management information 140 based on the second history 132. Referring to FIG. 8, in S218, the user US0 can utter a notification request instruction NI such as “Tell me the details of the management information”. In this case, “the details of” is used as a keyword KE0 to request for notification of the management information 140 based on the first history 131 and the management information 140 based on the second history 132. The smart speaker 300 converts the voice of the notification request instruction NI into an audio signal SG1 (S218), and the voice mediation device 400 requests the voice UI for the notification request instruction NI based on the audio signal SG1 (S220). Then the voice UI passes the user ID information UID to the cloud print service, and requests for notification of the management information 140 based on the first history 131, and the management information 140 based on the second history 132 (S222). Based on the history 130, the cloud print service generates the management information 140 based on the first history 131, and the management information 140 based on the second history 132 (S224). Subsequently, the cloud print service performs the processes in and after S242 illustrated in FIG. 9, thus the management information 140 as illustrated in FIG. 11 is notified.

FIG. 11 schematically illustrates an example of output of the management information 140 in which verbal instruction print and non-verbal instruction print are separated. In the example illustrated in FIG. 3, let us assume that the current month is January. In this case, based on the history 130, the cloud print service tallies the number of printed pages NP, the operating time T0, the number of types of content NC based on the first history 131 which is the history of verbal instruction print, and tallies the number of printed pages NP, the operating time TO, the number of types of content NC based on the second history 132 which is the history of non-verbal instruction print. In addition, the cloud print service generates the number of page limitation information INP, the operating time limitation information ITO, and the number of type limitation information INC based on the result of the tally in verbal instruction print, and generates the number of page limitation information INP, the operating time limitation information ITO, and the number of type limitation information INC based on the result of the tally in non-verbal instruction print. Thus, the cloud print service generates the management information 140 as illustrated in FIG. 11 with a first section 141 and a second section 142 separated, and notifies the notification destination DES of the management information 140, the first section 141 being based on the first history 131 which is the history of verbal instruction print, the second section 142 being based on the second history 132 which is the history of non-verbal instruction print.

In the above manner, in this specific example, of the management information 140, the first section 141 based on the history of verbal instruction print, and the second section 142 based on the history of non-verbal instruction print can be separately identified, thus the convenience of the printing system SY1 can be improved.

As illustrated in FIG. 12, the printing system SY1 can notify of the management information 140 generated from the print history on a specified date. FIG. 12 schematically illustrates a process of receiving an instruction for date and notifying of the management information 140. Here, S306 to S308 correspond to the management information generation step ST7. S310 to S312 correspond to the management information notification step ST8. S306 corresponds to the instruction acquisition function FU1 performed by the instruction acquisition unit 111. S308 corresponds to the management function FU2 performed by the management unit 122. S310 corresponds to the transmission function FU4 performed by the transmitter 124.

When the user US0 utters date and the number of page notification request instruction NI1 to the smart speaker 300, the smart speaker 300 converts the voice from the user US0 into an audio signal SG1, and transmits the audio signal SG1 to the voice mediation device 400 (S302). The number of page notification request instruction NI1 is an instruction to request for notification of the management information 140 including at least one of the number of printed pages NP of the printed material 600 produced by the user US0 on the above-mentioned date and the number of page limitation information INP which indicates whether the number of printed pages NP has reached an upper limit number NPmax. The number of page notification request instruction NI1 is included in the instructions obtained from the voice mediation device 400. For example, when the first user US1 of the user ID information “UID11” illustrated in FIG. 3 utters “Tell the number of printed pages on January 11”, “on January 11” is a keyword showing the date, and “the number of printed pages” and “Tell me” are keywords showing the number of page notification request instruction NI1.

After receiving the audio signal SG1, the voice mediation device 400 acquires the user ID information UID, analyzes the voice based on the audio signal SG1, extracts each keyword KE0 from results of the analysis of the voice, and passes the user ID information UID and the keyword KE0 to the voice UI to request for the number of page notification request instruction NI1 (S304). When acquiring the keywords KE0 as the date and the number of page notification request instruction NI1 along with the user ID information UID from the voice mediation device 400, the voice UI passes the user ID information UID to the cloud print service, and requests for notification of the number of printed pages on a specified date (S306). After receiving the request from the voice UI, the cloud print service generates the management information 140 including at least one of the number of printed pages NP and the number of page limitation information INP based on the history 130 (S308). In the example illustrated in FIG. 3, the number of printed pages NP associated with the user ID information “UID11” is 10. When notifying of the number of page limitation information INP instead of or along with the number of printed pages NP, the cloud print service generates the number of page limitation information INP which indicates whether the number of printed pages NP has reached an upper limit number NPmax. Thus, the management unit 122 of the server 100 generates management information 140 including at least one of the number of printed pages NP and the number of page limitation information INP based on the history 130.

After the management information 140 is generated, the cloud print service performs a process of notifying a notification destination DES of the above-described management information 140, the notification destination DES being set in association with the user ID information UID (S310). When the smart speaker 300 is set as the notification destination DES, the cloud print service requests the voice UI for notification of the management information 140, such as “The number of printed pages in January 11 is 10” or “The number of printed pages in January 11 has not reached the upper limit number”. After receiving the request from the cloud print service, the voice UI requests the voice mediation device 400 to read out the management information 140, such as “The number of printed pages in January 11 is 10” or “The number of printed pages in January 11 has not reached the upper limit number” (S312) as the guidance message GM1. In this manner, the transmitter 124 of the server 100 notifies the notification destination DES of the management information 140 including at least one of the number of printed pages NP and the number of page limitation information INP.

After receiving the guidance message GM1, the voice mediation device 400 converts the guidance message GM1 into an audio signal SG1, and transmits the audio signal SG1 via the network NE1 to the smart speaker 300 which has been set as the notification destination DES (S314). After receiving the audio signal SG1, the smart speaker 300 converts the audio signal SG1 into voice, and outputs the voice (S316). Consequently, management information 140, such as “The number of printed pages in January 11 is 10” or “The number of printed pages in January 11 has not reached the upper limit number” is read out by voice for the user US0. In this specific example, the user US0 can identify at least one of the number of printed pages NP on a requested date and the number of page limitation information INP, thus the convenience of management of printing can be improved.

As illustrated in FIG. 13, based on the history, the printing system SY1 can notify of the management information 140 associated with the print condition 730 specified. FIG. 13 schematically illustrates a process of receiving an instruction for the print condition 730 and notifying of the management information 140. Here, S406 to S408 correspond to the management information generation step ST7. S410 to S412 correspond to the management information notification step ST8. S406 corresponds to the instruction acquisition function FU1 performed by the instruction acquisition unit 111. S408 corresponds to the management function FU2 performed by the management unit 122. S410 corresponds to the transmission function FU4 performed by the transmitter 124.

When the user US0 utters a condition specific instruction CSI and a specific condition notification request instruction NI2 to the smart speaker 300, the smart speaker 300 converts the voice from the user US0 into an audio signal SG1, and transmits the audio signal SG1 to the voice mediation device 400 (S402). The condition specific instruction CSI is an instruction to identify the print condition 730 as illustrated in FIG. 3, and is included in the instructions acquired from the voice mediation device 400. The specific condition notification request instruction NI2 is an instruction to request for notification of the management information 140 matching the identified print condition 730, and is included in the instructions acquired from the voice mediation device 400. For example, when the first user US1 of the user ID information “UID11” illustrated in FIG. 3 utters “Tell the number of printed pages in color print this month”, “in color print” is used as a keyword KE0 showing the condition specific instruction CSI, and “this month”, “the number of printed pages”, and “tell me” are used as keywords KE0 showing the specific condition notification request instruction NI2.

After receiving the audio signal SG1, the voice mediation device 400 acquires the user ID information UID, analyzes the voice based on the audio signal SG1, extracts each keyword KE0 from results of the analysis of the voice, and passes the user ID information UID and the keyword KE0 to the voice UI to request for the condition specific instruction CSI and the specific condition notification request instruction NI2 (S404). When acquiring the keywords KE0 as the condition specific instruction CSI and the specific condition notification request instruction NI2 along with the user ID information UID from the voice mediation device 400, the voice UI passes the user ID information UID and the print condition 730 to the cloud print service, and requests for notification of management information 140 matching the print condition 730 (S406). After receiving the request from the voice UI, the cloud print service generates management information 140 matching the passed print condition 730 based on the history 130 (S408). When the current month is January, in the example illustrated in FIG. 3, the number of printed pages in color print NP associated with the user ID information “UID11” is 22.

After the management information 140 is generated, the cloud print service performs a process of notifying a notification destination DES of the above-described management information 140, the notification destination DES being set in association with the user ID information UID (S410). When the smart speaker 300 is set as the notification destination DES, the cloud print service requests the voice UI for notification of the management information 140, such as “The number of printed pages in color print this month is 22”. After receiving the request from the cloud print service, the voice UI requests the voice mediation device 400 to read out the management information 140, such as “The number of printed pages in color print this month is 22” as the guidance message GM1 (S412). In this manner, the transmitter 124 of the server 100 notifies the notification destination DES of the management information 140 matching the print condition 730 identified by the condition specific instruction CSI.

After receiving the guidance message GM1, the voice mediation device 400 converts the guidance message GM1 into an audio signal SG1, and transmits the audio signal SG1 via the network NE1 to the smart speaker 300 which has been set as the notification destination DES (S414). After receiving the audio signal SG1, the smart speaker 300 converts the audio signal SG1 into voice, and outputs the voice (S416). Consequently, management information 140, such as “The number of printed pages in color print this month is 22” is read out by voice for the user US0. In this specific example, the user US0 can identify the management information 140 matching the print condition 730 specified by the user US0, thus the convenience of management of printing can be improved.

### 4. Modifications

The present disclosure allows various modifications. The voice I/O device to which the present technique is applicable is not limited to the smart speaker 300, and may be a terminal 500 such as a smartphone and a tablet, or a personal computer. The storage 121 storing the history 130 is not necessarily provided in the cloud print service, and may be provided in the voice UI. The processes described above may be modified as appropriate, for example, the processes may be changed in order. For example, in the process illustrated in FIG. 7, the process of storing the history 130 in S116 and the process of notifying of completion of printing in S118 may be replaced.

Notification of the management information 140 is not necessarily triggered by a notification request instruction NI of the user US0. For example, notification of the management information 140 may be made regularly, such as every month. Note that even when the notification destination DES of the management information 140 is restricted to the voice I/O device, when the notification destination DES of the management information 140 is restricted to the printing device, or when the notification destination DES of the management information 140 is restricted to the terminal 500, the basic effect, that is, improving the convenience of management of printing is obtained.

### 5. Conclusion

As described above, the present disclosure can provide techniques to improve the convenience of management of printing in various aspects. Even with a technique consisting of only the claim components according to independent claims, basic operations and effects described above are obtained. Also, it is possible to implement configurations in which the components disclosed in the above-described examples are replaced, or a combination is changed, and configurations in which the components disclosed in publicly known techniques and the above-described examples are replaced, or a combination is changed. These configurations are also included in the present disclosure.

What is claimed is:

1. A printing system comprising:
a printing device; and
a server connected to the printing device via a network, wherein
the server includes:
an instruction acquisition unit that acquires an instruction verbally given by a user from a voice mediation device, the instruction including a print instruction;
a transmitter that transmits print data based on the acquired print instruction to the printing device;
a storage that stores a history of printing based on the print instruction in association with identification information of the user; and
a management unit that generates management information to manage the printing by the user based on the history in association with the identification information,
the transmitter transmits the generated management information to a notification destination, and
the printing device receives the print data, and performs printing in accordance with the print data.

2. The printing system according to claim 1, wherein
the identification information of the user is associated with account information including a transmission destination of the printing device, and
the transmitter transmits the print data to the printing device indicated by the account information associated with the identification information.

3. The printing system according to claim 2, wherein
the identification information is associated with the account information,
the history is associated with the identification information, and
the management information is information on the user indicated by the identification information.

4. The printing system according to claim 1, wherein
the instruction includes a notification request instruction to request for notification of the management information, and
the management unit generates the management information with acquisition of the notification request instruction by the instruction acquisition unit serving as a trigger.

5. The printing system according to claim 4, wherein
the instruction acquisition unit acquires the notification request instruction, and the identification information of the user from the voice mediation device, and
the management unit generates the management information based on the history associated with the acquired identification information.

6. The printing system according to claim 1, wherein
the storage stores a first history and a second history in association with the identification information of the user, the first history being the history of the print instruction verbally given by the user, the second history being a history of another print instruction non-verbally given by the user,
the management unit generates the management information with the first history and the second history separated, and
the transmitter transmits to the notification destination the management information with a section based on the first history and a section based on the second history separated.

7. The printing system according to claim 1, wherein
the notification destination includes a voice I/O device connected to the voice intermediate device via the network, and
the transmitter requests the voice mediation device to read out the management information by the voice I/O device.

8. The printing system according to claim 1, wherein
the notification destination includes the printing device,
the transmitter transmits the management information to the printing device, and
the printing device receives the management information, and prints the management information.

9. The printing system according to claim 1, wherein
the notification destination includes a terminal connected to the server via the network, and
the transmitter transmits the generated management information to the terminal.

10. The printing system according to claim 1, wherein
the transmitter receives setting of the notification destination, and transmits the management information to the received notification destination.

11. The printing system according to claim 1, wherein
the management unit generates the management information based on the history associated with the identification information, the management information including at least one of a number of pages of printed material produced by the user in a predetermined period, and number of page limitation information which indicates whether the number of pages reached an upper limit number, and
the transmitter transmits the management information including at least one of the number of pages and the number of page limitation information to the notification destination.

12. The printing system according to claim 1, wherein
the instruction includes a date, and further includes a number of page notification request instruction to request for notification of the management information including at least one of a number of pages of printed material produced by the user on the date, and number of page limitation information which indicates whether the number of pages reached an upper limit number,
the management unit generates the management information including at least one of the number of pages and the number of page limitation information based on the history associated with the identification information, and
the transmitter transmits the management information including at least one of the number of pages and the number of page limitation information to the notification destination.

13. The printing system according to claim 1, wherein
the history includes a print condition including one or more print settings and print setting values corresponding to the print settings,
the notification request instruction includes a condition specific instruction to identify the print settings, and a specific condition notification request instruction to request for notification of the print setting values corresponding to the identified print settings,
the management unit generates the identified print settings and notification information including the print setting values as the management information based on the specific condition notification request instruction, and
the transmitter transmits the notification information to the notification destination.

14. The printing system according to claim 1, wherein
the management unit generates the management information based on the history associated with the identification information, the management information including at least one of a time during which the printing device is operated by the user in a predetermined period, and an operating time limitation information which indicates whether the time reached an upper limit time, and
the transmitter transmits the management information including at least one of the time and the operating time limitation information to the notification destination.

15. The printing system according to claim 1, wherein
the management unit generates the management information based on the history associated with the identification information, the management information including at least one of a number of types of content printed by the user in a predetermined period, and number of type limitation information which indicates whether the number of types reached an upper limit number, and
the transmitter transmits the management information including at least one of the number of types and the number of type limitation information to the notification destination.

16. A server connected via a network to a printing device which performs printing in accordance with received data,
the server comprising:
an instruction acquisition unit that acquires an instruction verbally given by a user from a voice mediation device, the instruction including a print instruction;
a transmitter that transmits print data based on the acquired print instruction to the printing device;
a storage that stores a history of printing based on the print instruction in association with identification information of the user; and
a management unit that generates management information to manage the printing by the user, based on the history associated with the identification information,
wherein the transmitter transmits the generated management information to the notification destination.
